(19) United States
(12) Patent Application Publication
(10) Pub. No.: US 2019/0383072 A1
(43) Pub. Date: Dec. 19, 2019

(54) HIDDEN PIVOT FOR SWING DOORS

(71) Applicant: Oscar RODRIGUEZ RODRIGUEZ, Benito Juarez. Quintana Roo (MX)

(72) Inventor: Oscar RODRIGUEZ RODRIGUEZ, Benito Juarez. Quintana Roo (MX)

(21) Appl. No.: 15/774,258

(22) PCT Filed: Oct. 3, 2016
(86) PCT No.: PCT/MX2016/000100

§ 371 Date: May 7, 2018

(30) Foreign Application Priority Data
Nov. 20, 2015 (MX) MX/U/2015/000576

(51) Int. Cl. E05D 7/08; E05D 7/04

(52) U.S. Cl. CPC E05D 7/08; E05Y 2900/132; E05D 7/0415

(57) ABSTRACT

A HIDDEN PIVOT FOR SWING DOORS COMPRISING TWO PIECES. WHEREIN THE FIRST PIECE COMPRISES: A MAIN SUPPORT WITH A RIGHT SIDE ASSEMBLY HOLE, A SECONDARY SUPPORT WITH A RIGHT SIDE ASSEMBLY HOLE, AN ASSEMBLY PLURALITY, AN ADJUSTABLE BOLT WITH A CENTRAL ASSEMBLY HOLE, AN ADJUSTER ARM WITH A RIGHT SIDE ASSEMBLY HOLE, AN ASSEMBLY RIVET, A BOLT ADJUSTER SCREW, A MALE TOP PIVOT BASE, AND A FEMALE TOP PIVOT; AND THE SECOND PIECE COMPRISES: A MAIN SUPPORT WITH A RIGHT SIDE ASSEMBLY HOLE, A LEFT SIDE ASSEMBLY HOLE, A SECONDARY SUPPORT WITH A RIGHT SIDE ASSEMBLY HOLE, A LEFT SIDE ASSEMBLY HOLE, A FEMALE BOTTOM PIVOT, A STEEL SPHERIC BALIN, AND A FEMALE BOTTOM PIVOT BASE.

### TECHNICAL FIELD

THE OBJECT OF THE CURRENT INVENTION, AS EXPRESSED IN THE STATEMENT OF THIS DESCRIPTION, MAKES REFERENCE TO A HIDDEN PIVOT USED FOR FLAT DOORS.

### DESCRIPTION OF THE INVENTION

THE NOVELTY OF THIS INVENTION IS CLEARLY SHOWN IN THE DRAWINGS THAT ARE ATTACHED TO THE CURRENT APPLICATION, AND ACCORDING TO THE DESCRIPTION THAT BELOW WE DETAIL TO MODE, THAT THE ALPHA-NUMERIC REFERENCES THAT CORRESPOND TO EACH ONE OF THE STRUCTURAL ELEMENTS THAT SHAPE THIS INVENTION.

### BRIEF DESCRIPTION OF THE FIGURES

FIG. 1, IS A VIEW IN KIND OF HIDDEN PIVOT AND THE COMPONENTS' STRUCTURAL PARTS.

FIG. 2, IS A PERSPECTIVE VIEW OF THE TOP HIDDEN PIVOT SUPPORT.

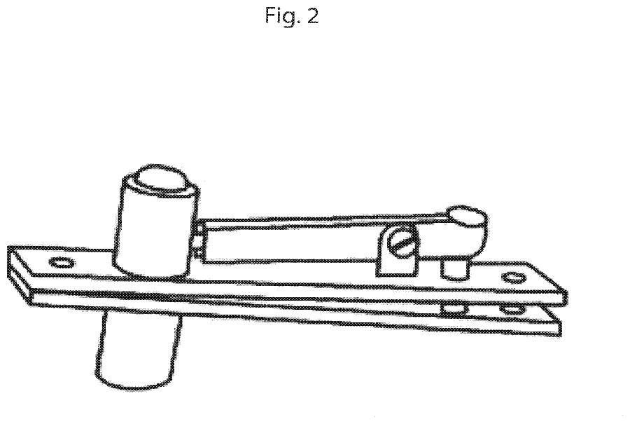

FIG. 3, IS A VIEW OF THE BOTTOM HIDDEN PIVOT SUPPORT.

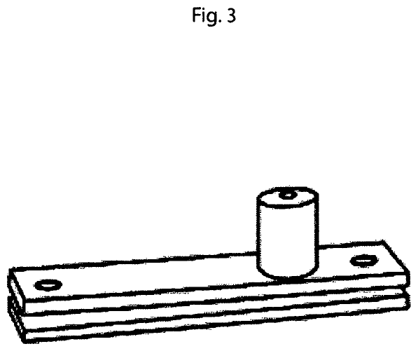

### INDETAILED DESCRIPTION OF THE INVENTION

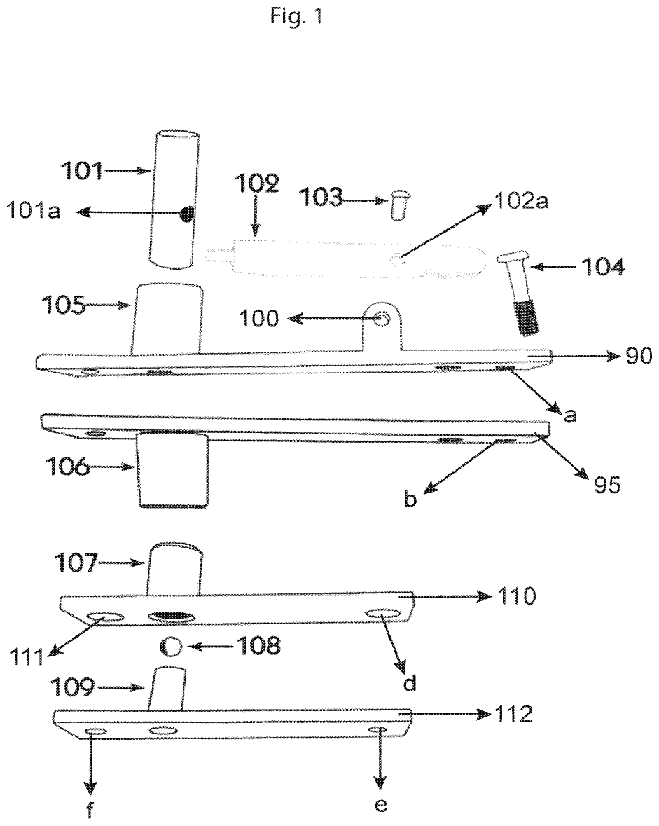

WITH A REFERENCE TO FIG. 1, THE HIDDEN PIVOT FOR SWING DOORS THAT COMPREHENDS TWO PARTS, THE FIRST PART CHARACTERIZED BECAUSE IT COMPREHENDS, A MAIN SUPPORT (90) WITH A RIGHT SIDE ASSEMBLY HOLE (a), A SECONDARY SUPPORT (95) WITH A RIGHT SIDE ASSEMBLY HOLE (b), AN ASSEMBLY PLURALITY (100), AN ADJUSTABLE BOLT (101) WITH A CENTRAL ASSEMBLY HOLE (101a), AN ADJUSTER ARM (102) WITH A RIGHT SIDE ASSEMBLY HOLE (102a), AN ASSEMBLY RIVET (103), A BOLT ADJUSTER SCREW (104), A MALE TOP PIVOT BASE (105), A FEMALE TOP PIVOT (106), THE SECOND PIECE CHARACTERIZED BECAUSE IT COMPREHENDS A PRIMARY SUPPORT (110) WITH A RIGHT SIDE ASSEMBLY HOLE (d), LEFT SIDE ASSEMBLY HOLE (111), A SECONDARY SUPPORT (112) WITH A RIGHT SIDE ASSEMBLY HOLE (e), LEFT SIDE ASSEMBLY HOLY (f), FEMALE BOTTOM PIVOT (107), A STEEL SPHERIC BALIN (108), AND A FEMALE BOTTOM PIVOT BASE (109).

THE HIDDEN PIVOT, IS DESIGNED TO FUNCTION ON SWING DOORS WITH WEIGHT LESS THAN 60 KILOGRAMS, HELPS THE FACT THAT SLANTED IN BOTH DIRECTION, BEING IDEALLY FOR KITCHEN DOORS AND RESTAURANT DOORS THANKS TO ITS ADJUSTABLE BOLT, IN ITS DESIGN IS BUILT TO PROVIDE A SOFT AND QUIET DISPLACEMENT, FURTHERMORE OF HAVING AN ADJUSTER SCREW, SO THE DOOR'S INSTALLATION BECOMES AN EASY AND SIMPLE TASK. ITS DESIGN ALLOWS ITS INSTALLATION ON DOORS WITH A 20 CM WIDTH AND A 30-130 MM THICKNESS, THANKS TO ITS ADJUSTABLE BOLT, IT IS OF AN EASY HANDLING AND ASSEMBLY, THE COMPLETE SYSTEM'S INSTALLATION IS DONE WITHIN THE VAIN GIVING THIS WAY A POSSIBILITY TO HIDE THE DOOR IN BETWEEN THE WALLS AND ITS EMBEDDED INSTALLATION, MAKES IT DISAPPEAR TO THE EYE-SIGHT WHEN IT IS IN A CLOSED POSITION.

THANKS TO ITS DESIGN, THE PIVOT ONLY ALLOWS A SEPARATION BETWEEN THE DOOR AND THE FLOOR OF UP TO 12 MM, ITS INSTALLATION DESIGN ALLOWS AN EASY HANDLING AND ASSEMBLY IN AS MUCH AS DUE TO ITS SUPPORT IS COMPREHENDED AMONG TWO PIECES WHICH FIRST THEY ARE INSTALLED INDIVIDUALLY ON THE FLOOR AND AT THE DOOR, AS WELL AS THE BOTTOM SUPPORT ON THE TOP FRAME AND THE DOOR'S BOTTOM PART, THE TOP SUPPORTS FEATURED OF THE TWO PARTS, THE MAIN SUPPORT AND THE SECONDARY, THE SECONDARY SUPPORT IS THAT ONE THAT IS FIXED AT THE DOOR GIVING THIS WAY THE EASYNESS TO HANDLE THE DOOR AT THE ASSEMBLY TIME, AND THE PRIMARY SUPPORT THAT IS THE ONE THAT IS INSTALLED AT THE TOP FRAME AND IT IS THE ONE IN CHARGE OF THE DOOR'S SUPPORT AND STABILIZATION, THE TWO PARTS ARE UNITED AND FIXED WITH A BOLT THAT IS DISPLACED BY THE ADJUSTER SCREW, IN THE BOTTOM PART, IN THE SAME WAY, THE SUPPORT IS COMPREHENDED IN TWO PARTS, THE PRIMARY SUPPORT IS THAT ONE WHICH IS INSTALLED AT THE FLOOR, AND IN CHARGE OF HOLDING ALL THE DOOR'S WEIGHT WITH THE AID OF A CIRCULAR BALIN THAT IS LOCATED BETWEEN THE MAIN AND THE SECONDARY, THE SECONDARY IS INSTALLED AT THE DOOR AND IT HELPS IN THE DOOR'S STABILITY AND THE DOOR'S MOVILITY.

1. A HIDDEN PIVOT FOR SWING DOORS COMPRISING:
TWO PIECES, WHEREIN
THE FIRST PIECE COMPRISES:
A MAIN SUPPORT WITH A RIGHT SIDE ASSEMBLY HOLE,
A SECONDARY SUPPORT WITH A RIGHT SIDE ASSEMBLY HOLE,
AN ASSEMBLY PLURALITY,
AN ADJUSTABLE BOLT WITH A CENTRAL ASSEMBLY HOLE,
AN ADJUSTER ARM WITH A RIGHT SIDE ASSEMBLY HOLE,
AN ASSEMBLY RIVET,
A BOLT ADJUSTER SCREW,
A MALE TOP PIVOT BASE, AND
A FEMALE TOP PIVOT; AND
THE SECOND PIECE COMPRISES:
A MAIN SUPPORT WITH A RIGHT SIDE ASSEMBLY HOLE,
A LEFT SIDE ASSEMBLY HOLE,
A SECONDARY SUPPORT WITH A RIGHT SIDE ASSEMBLY HOLE,
A LEFT SIDE ASSEMBLY HOLE,
A FEMALE BOTTOM PIVOT,
A STEEL SPHERIC BALIN, AND
A FEMALE BOTTOM PIVOT BASE.

2. THE HIDDEN PIVOT FOR SWING DOORS ACCORDING TO CLAIM 1, WHEREIN
THE SECOND PIECE INCLUDES A MAIN SUPPORT WITH A RIGHT SIDE ASSEMBLY HOLE, A LEFT SIDE ASSEMBLY HOLE, A SECONDARY SUPPORT WITH A RIGHT SIDE ASSEMBLY HOLE, A LEFT SIDE ASSEMBLY HOLE, A FEMALE BOTTOM PIVOT, A STEEL SPHERIC BALIN, AND A FEMALE BOTTOM PIVOT BASE.

3. THE HIDDEN PIVOT FOR SWING DOORS ACCORDING TO CLAIM 1, FURTHER COMPRISING:
THE MAIN SUPPORT WITH THE RIGHT SIDE ASSEMBLY HOLE.

4. THE HIDDEN PIVOT FOR SWING DOORS ACCORDING TO CLAIM 1, FURTHER COMPRISING:
THE SECONDARY SUPPORT WITH THE RIGHT SIDE ASSEMBLY HOLE.

5. THE HIDDEN PIVOT FOR SWING DOORS ACCORDING TO CLAIM 1, FURTHER COMPRISING:
THE ASSEMBLY PLURALITY ON THE MAIN SUPPORT.

6. THE HIDDEN PIVOT FOR SWING DOORS ACCORDING TO CLAIM 1, FURTHER COMPRISING:
THE ADJUSTABLE BOLT WITH THE CENTRAL ASSEMBLY HOLE, AND THE ADJUSTER ARM.

7. THE HIDDEN PIVOT FOR SWING DOORS ACCORDING TO CLAIM 1, FURTHER COMPRISING:
THE ASSEMBLY RIVET.

8. THE HIDDEN PIVOT FOR SWING DOORS ACCORDING TO CLAIM 1, FURTHER COMPRISING:
THE BOLT ADJUSTER SCREW.

9. THE HIDDEN PIVOT FOR SWING DOORS ACCORDING TO CLAIM 1, FURTHER COMPRISING:
THE MALE TOP PIVOT BASE.

10. THE HIDDEN PIVOT FOR SWING DOORS ACCORDING TO CLAIM 1, FURTHER COMPRISING:
THE FEMALE TOP PIVOT.

11. THE HIDDEN PIVOT FOR SWING DOORS ACCORDING TO CLAIM 2, FURTHER COMPRISING:
THE SECONDARY SUPPORT WITH THE RIGHT SIDE ASSEMBLY HOLE, AND
THE LEFT SIDE ASSEMBLY HOLE.

12. THE HIDDEN PIVOT FOR SWING DOORS ACCORDING TO CLAIM 2, FURTHER COMPRISING:
THE FEMALE BOTTOM PIVOT.

13. A HIDDEN PIVOT FOR SWING DOORS ACCORDING TO CLAIM 2, FURTHER COMPRISING:
THE STEEL-SPHERIC BALIN.

14. THE HIDDEN PIVOT FOR SWING DOORS ACCORDING TO CLAIM 2, FURTHER COMPRISING:
THE FEMALE BOTTOM PIVOT BASE.
